(19) United States
(12) Patent Application Publication
(10) Pub. No.: US 2011/0249529 A1
(43) Pub. Date: Oct. 13, 2011

(54) FLANGE STIRRER

(76) Inventor: Martin Hirzel, Blumberg (DE)

(21) Appl. No.: 13/139,945

(22) PCT Filed: Dec. 23, 2009
(86) PCT No.: PCT/EP09/09248

§ 371 Date: Jun. 15, 2011

(51) Int. Cl. B01F 7/00

(52) U.S. Cl. 366/343

(57) ABSTRACT

The invention relates to a stirring element and to a stirrer, in particular for industrial stirrers, formed of a shaft, at least one torque arm (2), and at least one stirring element (3), wherein at least one, preferably three stirring elements (3) are penetrated in the stirring direction (5) by a plane-like cross-sectional surface of a cutout (7).

The invention relates to a stirring element, in particular for industrial stirrers, as recited in the preamble to claim 1.

Industrial stirrers are used for stirring, mixing, or blending materials or substances such as liquids, powdered substances, or paste-like compounds. This places various demands on the stirring method and the stirring result; an essential criterion is the selection of the geometric shape of a stirring element. In the present context, industrial stirrers should be understood to include any kind of stirring mechanisms used in a production context, be they stirring mechanisms used in the food industry, the paint industry, the construction industry, or environmental engineering, for example.

It is known that liquid substances, for example those with high viscosities, or mixtures of substances with different viscosities of the starting materials, or paste-like compounds are difficult to stir in a way that achieves a homogeneous blending or mixing of the individual components into a uniform whole. It is particularly necessary to bear in mind the importance of avoiding dead zones in the flow during the mixing motion which would then lead to inhomogeneities in the final product.

The shape of the stirring container is also always another selection criterion for the embodiment of a stirrer.

It is known that when stirring containers with a square container shape are used, often only an insufficient mixing or blending occurs in the corner regions if the stirring element is not specially adapted for this stirring task.

Specially adapted stirring elements, however, are often associated with significant investment costs, particularly in the food sector where it is necessary to provide (stainless steel) surfaces that are efficient to clean; these surfaces must be machined so that they are free of edges and dirt-collecting grooves. The option of a simple cleaning of the stirring element is also an important criterion for its selection.

For this reason, the object of the invention is to modify a stirring element, particularly for industrial stirrers, in a way that enables an inexpensive manufacture of stirring elements that are adapted to a multitude of stirring tasks.

The object of the invention is attained by the defining characteristics of claim 1.

Advantageous modifications and suitable embodiments of the invention are described in the dependent claims.

The invention is based on a stirring element, particularly for industrial stirrers, in which the stirring element is embodied with a plane-like cross-sectional area in the stirring direction.

In most cases, the stirring element is moved through a medium to be stirred. The stirring direction corresponds to this movement direction; in the case of a rotating stirrer, the stirring direction is understood to essentially be the direction oriented tangential to a circular path at a given moment in time. Consequently, the stirring direction changes in a corresponding fashion along the circular path of the rotating stirrer.

The stirring element can, without significant limitations, be adapted to the respective stirring task in terms of its shape, dimensions, and position relative to a stirring shaft that produces the stirring motion.

The stirring element according to the invention is characterized in that the plane-like cross-sectional area of the stirring element is interrupted by an opening, i.e., it has a hole in its surface area.

Tests with a stirring element of this kind, which is interrupted by an opening in its plane-like cross-sectional surface, have demonstrated that after a stirring procedure, a medium to be stirred, e.g., a high-viscosity or even gel-like compound, has been blended/mixed with a required homogeneity, particularly also to some degree in the corner regions of square stirring containers.

In addition, the tests demonstrate that the thorough mixing of the medium that occurs during the stirring procedure with the stirring element according to the invention takes place even at relatively low stirrer speeds, which are reduced by approximately half as compared to known stirrers from the prior art.

In a preferred embodiment of the invention, the opening is situated in the center of the plane of the stirring element. The centrally situated opening permits an increased symmetry of a flow profile produced during the stirring procedure, thus making it possible to achieve an improved homogenizing action. A centrally situated opening also reduces the manufacturing costs of such a stirring element since this symmetry is often present in standard parts available from other sectors, which can, for example, be used as components for manufacturing such a stirring element.

In another preferred embodiment of the invention, the stirring element is composed of a flat element and a flange. In the medium to be stirred, the flange element constitutes an enlarged stirring cross-sectional area in the stirring direction; the flange, which is situated after the flat element, produces a funneling effect and therefore influences the stirring flow profile.

In another preferred embodiment of the invention, the flange adjoins the central opening. This has the advantage that the medium to be stirred can flow through the opening. The resulting stirring flow profile is thus further improved so that for example toroidal rotational flows (similar to a smoke ring of cigarette smoke) can form around the stirring element.

In another preferred embodiment of the invention, the flange is embodied to be as long as or longer than the material thickness of the flat element in the stirring direction. If the flange is embodied to be the same length as the thickness of the flat element, then this achieves an optimized flow behavior of the medium, thus producing a favorable thorough mixing of the medium to be stirred. For example, if the flange is embodied to be longer than the thickness of the flat element in the stirring direction, then it is possible to utilize the advantages of a tubular stirrer and its stirring behavior, for example in a viscous medium.

In another preferred embodiment of the invention, the ratio of the area of the flat element to the area of the opening lies in a range from at least 0.5:1 to 1:x>1. Ratios of the annular surface area to the inner diameter area of 0.8 to 8 have turned out to be a suitable combination that can be implemented using standard parts. This area ratio of the annular area of a flat element to the area of the opening assures that the stirring element according to the invention forms a sufficient plane-like cross-sectional area to produce the above-mentioned advantages such as a homogeneous medium at a low rotation speed of the stirrer. Often, however, the stated object is also expanded to include the fact that as the stirring speed increases, an axial vortex that forms must not extend to the stirring element since otherwise, air would get sucked into the material being stirred. In individual cases, this can also be a desirable thing.

In another preferred embodiment of the invention, the flat element is embodied in the form of a round, oval, or square element. Embodying the flat element with different flat shapes has the advantage of permitting the plane-like cross-sectional area of the flat element to be adapted to the respective stirring task, the medium to be stirred, and the container shape.

In another preferred embodiment of the invention, the opening and the flange adjoining it are embodied as round, oval, or square. This has the advantage that the cross-sectional area of the opening and the adjoining circumferential surface of the flange can be embodied differently depending on the stirring task.

In another preferred embodiment of the invention, the stirring element is attached to a shaft by means of a threaded connection, a welded connection, or an adapter connection, preferably by means of spokes. An alternative attachment of the stirring element to the stirring shaft, for example by means of an articulating connection, has the advantage that the stirrer can be inserted into a container opening in a swiveled-in position; this permits the diameter of the opening to be smaller than the effective stirring diameter. During the stirring procedure, centrifugal force causes the stirring elements connected in swinging fashion by the articulating connection to open out into a larger effective radius.

In another preferred embodiment of the invention, the stirring element is a welding flange. This has the advantage that standard parts can be used for manufacturing a stirring element according to the invention, which advantageously reduces the manufacturing costs of such a stirrer.

Another aspect of the invention is based on a stirrer, in particular an industrial stirrer, which is composed of a drive shaft, at least one spoke, and at least one stirring element.

In this case, the effective stirring diameter can be adapted to the geometry of the respective stirring container through corresponding adaptation of the length of the spoke.

The essence of this aspect lies in the fact that at least one, preferably three, stirring elements according to the invention is/are provided.

Because a stirrer can have a freely selectable number of stirring elements according to the invention, this stirrer can be adapted to the respective stirring task and/or to the stirring container and its dimensions. Selecting the number of stirring elements offers the possibility of adjusting the symmetry around the rotation center in order to minimize bearing stresses on the drive shaft. Basically, though, it is also conceivable for slow-running stirrers to have a single stirring element.

In another preferred embodiment of the stirrer according to the invention, the stirring element is embodied so that it is able to rotate on the shaft and/or pivot on the spoke. This has the advantage that the spatial position of the cross-sectional area of the plane-like flat element can be adapted to the respective stirring task and to the medium to be stirred as well as to the dimensions and shape of the stirring container, in particular to the insertion opening. In particular, by means of a pivoting of the stirring element on the spoke, i.e., a change in the vertical orientation of the stirring element relative to the drive shaft, it is possible to adjust a vertical action of the stirrer, which can have a stabilizing effect on the rotary motion, for example by causing the stirrer to experience a downward pulling force.

Additional defining characteristics of the invention ensue from the following description of the drawings and from the drawings themselves.

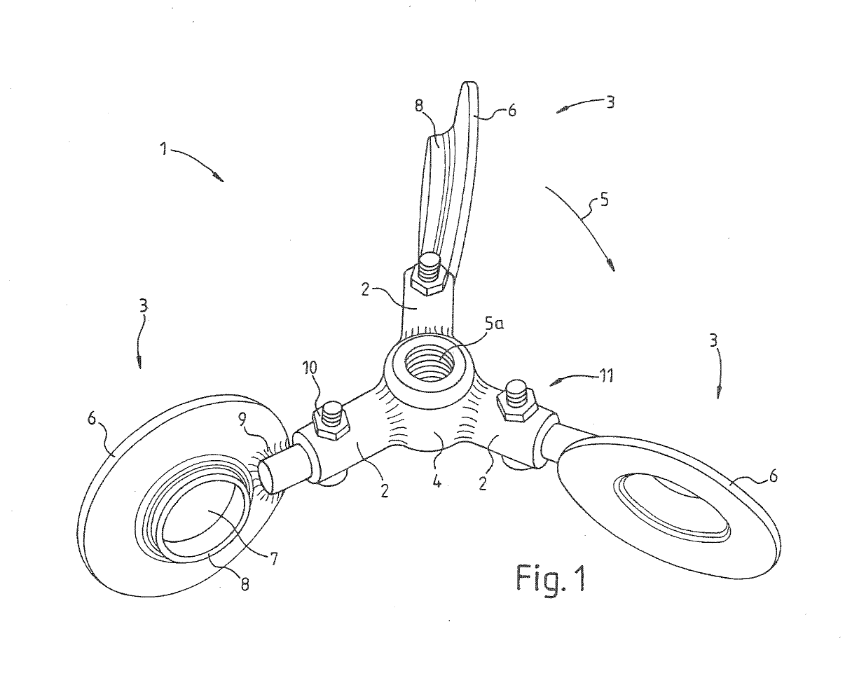

FIG. 1 is a perspective depiction of a stirrer to be positioned at a shaft end;

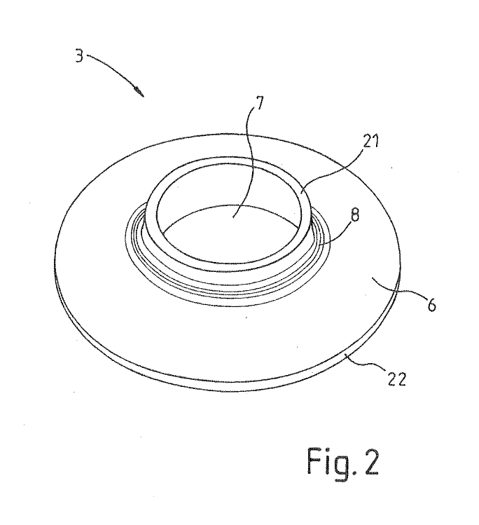

FIG. 2 is a rear view of a flat element with a central opening adjoined by a flange;

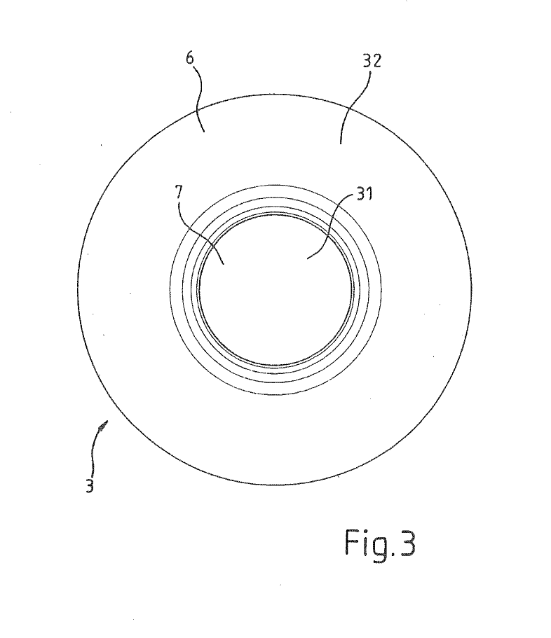

FIG. 3 is a front view of a flat element with a central opening;

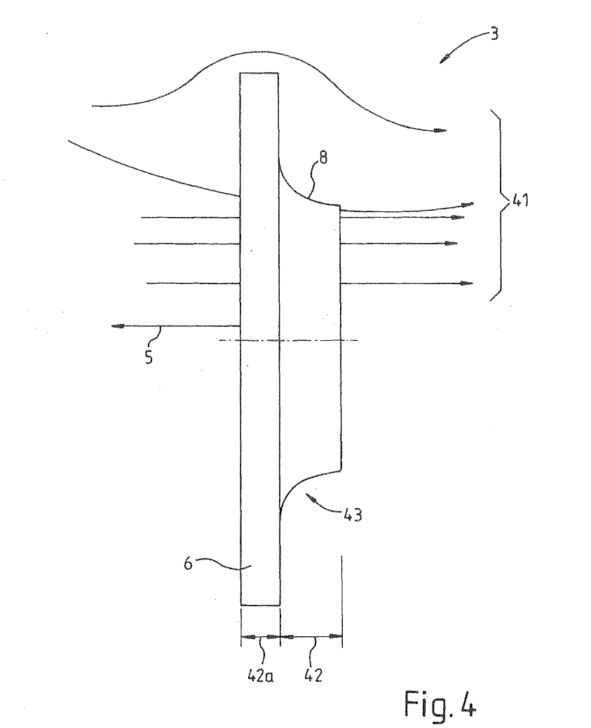

FIG. 4 is a side view of a stirring element according to the invention.

FIG. 1 is a detailed depiction of a stirrer 1 according to the invention, which has stirring elements 3 arranged on spokes 2, in this case oriented radially symmetrically around a hub 4, spaced apart from one another by 120° . The stirring elements are tilted slightly relative to the vertical, which is achieved by rotating them along the axis of the spokes 2. The hub 4 also has a shaft receptacle 5a in the middle, which, by means of a threaded bore, permits the stirrer 1 to be fastened to a motor-driven shaft (not shown here). In the technique as applied, the stirrer 1 is set into rotation via the shaft in such a way that the stirring elements 3 are moved along the stirring direction 5.

On the one hand, the stirring element 3 has a flat element 6 with a central opening 7 that constitutes the front side in terms of the stirring direction. On the back side in terms of the stirring direction, the stirring element 3 has a flange 8 that in this case adjoins the opening 7. With proper use of the stirrer 1, the stirring element 3 is consequently moved in the stirring direction 5 through the medium to be stirred, with the flat element 6 in front; the medium to be stirred that comes into contact with the surface of the flat element 6 on the one hand, flows through the opening 7 and flange 8 adjoining it and on the other hand, also flows around the stirring element 3.

In the present exemplary embodiment, the stirring elements 3 are each welded by means of a welding seam 9 to a respective piece of round stock, which is in turn inserted into a stirring element fastener 10 on the spoke 2. The stirring element fastener 10 includes a grub screw, which in this case clamps the round stock that is welded to the stirring element 3. The stirring element fastener 10 that is fastened to the spoke 2 serves as a kind of connecting adapter 11, which permits the stirring element 3 to be connected via the spoke 2 to the hub 4 and therefore to the drive shaft via the shaft receptacle 5. Other adapter embodiments such as threaded ones are also conceivable. In addition, the rotationally symmetrical embodiment of the connecting adapter 11 permits the stirring element 3 to be tilted slightly in its vertical orientation relative to the drive shaft, thus permitting an improved stirring behavior, particularly with regard to a downward-pulling moment of force, similar to a screw. The spoke 2 in the present case is in turn likewise attached to the hub 4 by means of welding seams as a result of which the stirrer 1 forms a unit composed of three stirring elements 3 with corresponding fastening devices and connecting adapters.

For larger embodiments of the stirrer according to the invention, the stirring elements can also be welded to the spokes in the region of the flange or on the surface adjacent to the flange by means of mounts that are adapted to the flange shape in order to withstand the considerable shear forces during the stirring.

The exemplary embodiment shown in FIG. 1, however, shows only a prototype. In materials processing, it would be more suitable to embody a stirrer with the appearance of a one-piece design, particularly in the food industry but also in a multitude of other uses. Selecting a design of this kind would be necessary since the multitude of openings and undercuts depicted here would constitute a virtually impossible complexity with regard to the cleaning of the stirrer 1. In actual use, it must therefore be assumed that a particular arrangement of stirring elements 3 is welded via spokes 2 directly to a hub 4;

welding seams must then be polished as smoothly as possible and thus rendered unsusceptible to dirt deposits. A corresponding adjustment angle of the stirring element verticals relative to a drive shaft offers the advantage that a certain traction torque is exerted on the entire stirrer 1 in the downward direction by the screw-like application of force, which in turn stabilizes the rotational movement of the stirrer 1 on the shaft, particularly with regard to a build-up of oscillation resonances.

FIG. 2 shows a stirring element 3 according to the invention in the form of a welding flange, which once again is a standard part. FIG. 2 shows the rear view of the welding flange; the welding flange is composed of a flat element 6 and an adjoining flange 8. The flange 8 in this case has a flange wall thickness 21 that is selected to be approximately equal to the flat element wall thickness 22. The flange 8 in this case is connected to the flat element 6 via a smooth, continuously curved connection so that even in these areas, there is no reason to fear the occurrence of dirt deposits due to the presence of grooves or undercuts. Because of the opening 7 in the middle of the stirring element 3, the medium to be stirred can pass through when the stirring element is moved in the stirring direction 5, which in this case, is a movement down into the plane of the drawing.

FIG. 3 shows the front side of a stirring element 3 according to the invention in the form of a welding flange. The flat element 6 is smoothly connected to the flange 8 in the region of the opening 7, which likewise offers an improved cleanability in the present case. The area 31 of the opening 7 here, which corresponds to the flow cross-sectional area through the opening 7, has an effective stirring cross-section that is reduced by a factor of approx. 5.5 as compared to the area of the flat element 32. The medium to be stirred is thus moved in the stirring direction 5 by a portion of the area of the flat element 32 that is larger by a factor of approx. 5.5, while a smaller portion passes through the area of the opening 31. In this way, a flow profile around the stirring element 3 is produced, which achieves an appropriate, required thorough stirring due to its action on its surroundings.

FIG. 4 shows a side view of a stirring element 3 according to the invention in the form of a welding flange. The stirring element 3 in this case is being moved in the stirring direction 5; part of the flow pattern 41 is schematically depicted in the form of flow lines added to the drawing. The flow pattern 41 depicted here, however, is only a sketch of one possible flow scenario since the flow behavior of fluids around solid bodies is influenced essentially by the movement speed of the fixed body on the one hand and on the other, by the fluid mechanical properties such as the viscosity of the fluid medium. This can produce laminar flow conditions, which are rather undesirable for a mixing procedure, as well as turbulent or even chaotic flow patterns.

The stirring element 3 according to the invention has a thickness of the flat element 42a that in the present case is selected to be somewhat less than the length of the flange 42. By varying the length of the flange 42, i.e., the region in which a fluid to be stirred passes through the stirring element, different parameters can be adjusted with regard to the stirring result to be achieved.

The flange is connected to the flat element 6 at its flange edge, transitioning smoothly into it via the flange radius 43; the embodiment of the flange radius 43, either viewed from a flat section of the flat element 6 or, not shown here, also from the edge of the flat element 6, can be embodied by means of an elongated and possibly not purely circular radius. Such a smoothly transitioning flange radius 43 makes it possible to implement a stirring element 3 that has virtually no undercuts or indentations, which would otherwise result in dirt deposits or make it difficult to clean the device, for example when it is used in the food industry.

The invention is not, however, limited to the exemplary embodiments shown here; instead, it includes all embodiments that make use of concepts essential to the invention. In particular, these include standard parts of a similar nature, which have the properties claimed according to the invention.

### Reference Numeral List

1 stirrer
2 spoke
3 stirring element
4 hub
5 stirring device
5a shaft receptacle
6 flat element
7 opening
8 flange
9 welding seam
10 stirring element fastener
11 connecting adapter
21 flange wall thickness
22 flat element wall thickness
31 area of the opening
32 area of the flat element
41 flow pattern
42 length of the flange
42a thickness of the flat element
43 flange radius

What is claimed is:

1. A stirring element (3), in particular for industrial stirrers, in which the stirring element (3) is embodied with a plane-like cross-sectional surface in the stirring direction (5),
wherein the plane-like cross-sectional surface is interrupted by an opening (7).

2. The stirring element (3) as recited in claim 1, wherein the opening (7) is situated centrally in the plane of the stirring element (3).

3. The stirring element (3) as recited in one claim 1,
wherein the stirring element (3) is composed of a flat element (6) and a flange (8).

4. The stirring element (3) as recited in claim 1,
wherein the flange (8) adjoins the central opening (7).

5. The stirring element (3) as recited in claim 1,
wherein the flange (8) is embodied to be as long as or longer than the material thickness of the flat element (42a) in the stirring direction (5).

6. The stirring element (3) as recited in claim 1,
wherein the ratio of the area (32) of the flat element (6) to the cross-sectional area (31) of the opening (7) is embodied to lie a range of at least 0.5:1 to 1:x>1.

7. The stirring element (3) as recited in claim 1,
wherein the flat element (6) is embodied as a round, oval, or square element.

8. The stirring element (3) as recited in claim 1,
wherein the opening (7) and the adjoining flange (8) are embodied as round, oval, or square.

9. The stirring element (3) as recited in claim 1,
wherein the stirring element (3) is a welding flange.

10. A stirrer (1), in particular an industrial stirrer, which is composed of a shaft, at least one spoke (2), and at least one stirring element (3), wherein at least one, preferably three, stirring elements (3) as recited claim 1 is/are provided.

11. The stirrer (1) as recited in claim 10,
wherein the stirring element (3) is embodied as rotatable on the shaft and/or pivotable on the spoke (2).

12. The stirrer (1) as recited in claim 1,
wherein the stirring element (3) is attached to a shaft by means of a threaded connection and/or a welded connection and/or a connecting adapter (11).
